(19) United States
(12) Patent Application Publication
(10) Pub. No.: US 2013/0325932 A1
(43) Pub. Date: Dec. 5, 2013

(54) ELECTRONIC DEVICE AND METHOD FOR STORING DISTRIBUTED DOCUMENTS

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: CHUNG-I LEE, New Taipei (TW); DE-YI XIE, Shenzhen (CN)

(21) Appl. No.: 13/908,095

(22) Filed: Jun. 3, 2013

(30) Foreign Application Priority Data
Jun. 5, 2012 (CN) 201210181414X

(51) Int. Cl. H04L 29/06

(52) U.S. Cl. CPC H04L 29/06047
USPC 709/203

(57) ABSTRACT

In a method for storing distributed documents, document upload commands trigger a process for reviewing the status of a single FTP master server in a branch node. After ID information is taken from the document and recorded, a slave server may be appointed as master server depending on conditions relevant to the original master server. Copies of the document also spread out to the server systems in other branch nodes, utilizing in full the storage capacities of all servers and preventing bottlenecks.

### BACKGROUND

1. Technical Field

Embodiments of the present disclosure relate to document synchronization technology, and particularly to an electronic device and method for storing distributed electronic documents using the electronic device.

2. Description of Related Art

Globalized economic development creates multinational companies. Numerous multinational companies comprise a variety of departments distributed all over the world. Typically, a variety of information must be shared between multiple departments in a company. Data management and information sharing are pivotal for the efficient running of a multinational company. Departments need to access data and cooperate with each other over vast distances. Distributed database management systems are employed to enhance the efficiency of data access and to reduce error.

Many distributed database management systems have data stored in a variety of distributed physical locations, under a universal logic system. Users can access data stored in a remote storage as easily as data stored locally. However, each physical location has only one file transfer protocol (FTP) server for storing data in a current distributed database management system.

When the FTP server in one physical location is damaged, the documents stored in the FTP server will be lost if backups of the documents are not stored in other physical locations. In addition, a new FTP server with larger and more expensive storage capacity is needed when the storage space of an original FTP server is not enough, if storage is to be kept in a single new FTP server. Therefore, a more efficient method for storing distributed documents is desired.

### BRIEF DESCRIPTION OF THE DRAWINGS

FIG. 1 is a schematic block diagram of a plurality of branch-nodes and a network connecting them together.

FIG. 2 is a schematic block diagram of a detailed disclosure of one branch-node of FIG. 1.

FIG. 3 is a block diagram of one embodiment of an application server including a distributed document storing system.

FIG. 4 is a schematic block diagram of function modules of the distributed document storing system included in the application server.

FIG. 5 is a configuration table stored in a database server in one branch-node.

FIG. 6 is a summary table stored in a database server in one branch-node.

FIG. 7 is a flowchart of one embodiment of a method for storing distributed documents using an application server in one branch-node.

FIG. 8 is a flowchart of a detailed description of step S14 in FIG. 7.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other storage medium.

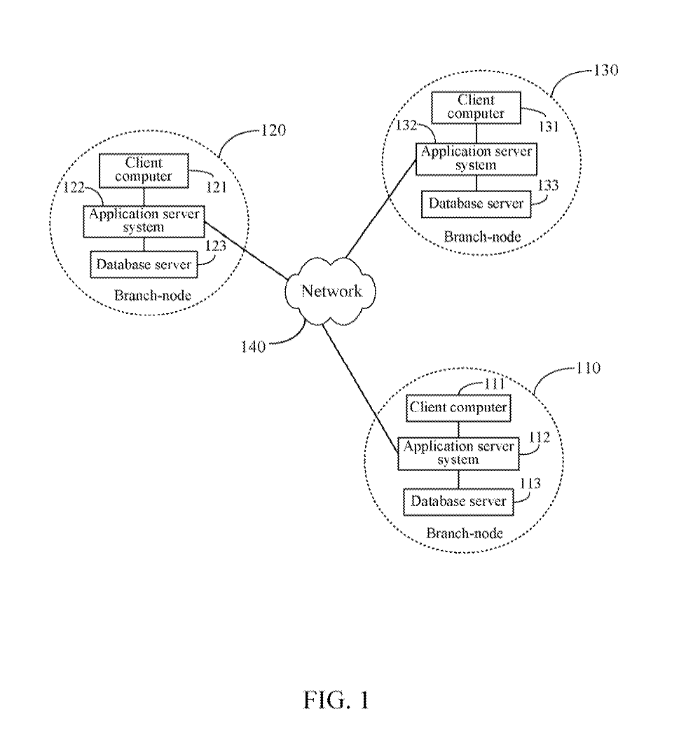

FIG. 1 is a schematic diagram of a plurality of branch-nodes and a network connecting them together. Documents are distributed in the plurality of branch-nodes (distributed documents). In one embodiment, three branch-nodes 110, 120, 130 are described and shown. For example, branch-node 110 is located in Shenzhen, China, branch-node 120 is located in New Taipei, Taiwan, and branch-node 130 is located in Los Angeles, United States. The branch-nodes 110, 120, 130 are connected to each other through a network 140. Each of the branch-nodes 110, 120, 130 includes a three-tier information system. For example, the three-tier information system of the branch-node 110 includes a database server 113 (the bottom tier), an application server system 112 (the middle tier), and a plurality of distributed client computers 111 (the top tier, only one is shown in FIG. 1).

The network 140 may be an intranet, the Internet or other suitable communication network, such as general packet radio service (GPRS), Wi-Fi/Wireless local area network (Wi-Fi/WLAN), third generation/Wideband code division multiple access (3G/WCDMA), or 3.5G/High-Speed downlink packet access (3.5G/HSDPA). The branch-node 120 is described below to exemplify the apparatus and function of each of the branch-nodes.

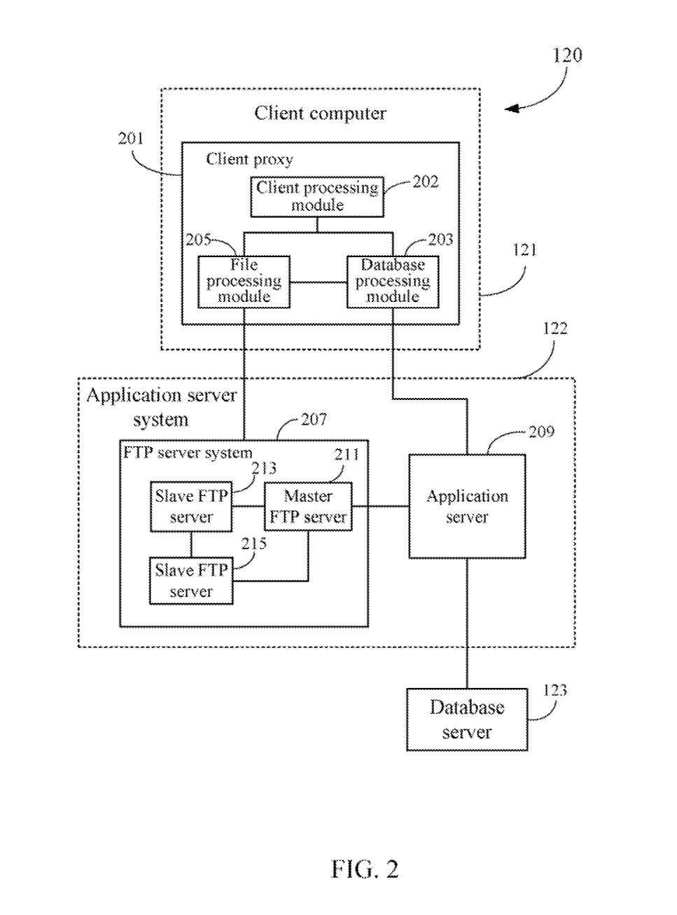

FIG. 2 is a schematic diagram of a detailed disclosure of the branch-node 120. The branch-node 120 includes a plurality of client computer 121 (only one is shown), an application server system 122, and a database server 123. The application server system 122 processes input of users and returns results of processing to users. The database server 123 manages processing of data stored in a database located therein. Such processing includes reading, writing, deleting, modifying, and backup. The structure of each of the branch-nodes 110, 130 is substantially the same as the structure of the branch-node 120.

The client computer 121 of the branch-node 120 includes a client proxy 201. The client proxy 201 separates executions for users from executions for the system (e.g., the operating system of the client computer 121), to simplify executions for users. The client proxy 201 includes a client processing module 202, a database processing module 203, and a file processing module 205. The application server system 122 of the branch-node 120 includes a file transfer protocol (FTP) server system 207 and an application server 209. The FTP server system 207 includes a plurality of slave FTP servers 213, 215, and one master FTP server 211. The master FTP server 211 provides both document upload and document download functions, and the slave FTP servers 213, 215 provide the document download function.

The client processing module 202 provides a graphical user interface (GUI) for users to input data. The client processing module 202 is connected to the database processing module 203 and the file processing module 205. The client processing module 202 sends commands to the file processing module 205 and the database processing module 203 for implementation, and displays the process results on the GUI.

The file processing module 205 is connected to the FTP server system 207, and sends file processing commands to the FTP server system 207. These file processing commands include read, edit, copy, save, update, and/or delete file, and the like. The file processing module 205 receives data from the database processing module 203.

The database processing module 203 is connected to the database server 123 via the application server 209. The database processing module 203 generates commands for searching, updating and deleting data stored in the database server 123, and sends results of implementation of the commands to the file processing module 205.

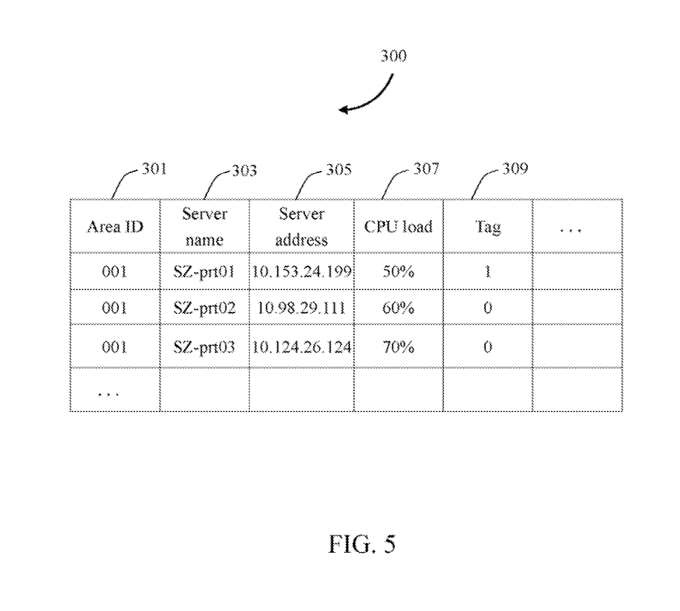

In one embodiment, the database server 123 stores a configuration table 300 (refer to FIG. 5), the configuration table 300 stores configuration information of all FTP servers in the FTP server system 207. For example, as shown in FIG. 5, the configuration table 300 includes area identifier (ID) 301, server name 303, server address 305, central processing unit (CPU) load 307, and tag 309 of each FTP server.

The area ID 301 records an ID of an area address of the branch-node 120, each branch-node has a unique area ID, for example, the area ID of the branch-node 120 is “001”. The server name 303 records a name (or a brief description) of a FTP server (e.g., the master FTP server or the slave FTP server). The server address 305 records an Internet protocol (IP) address of a FTP server, such as 10.153.24.199. The CPU load 307 records a current usage ratio of the CPU in each FTP server.

The tag 309 determines whether an FTP server is the master FTP server or the slave FTP server. For example, a first value “1” is used to indicate the master FTP server, and a second value “0” is used to indicate the slave FTP server. Each branch-node has one master FTP server and one or more slave FTP servers in the FTP server system. The master FTP server uploads and downloads documents, and the slave FTP server downloads documents. That is, the client computer 121 uploads the documents to the master FTP server 211.

The tag 309 of each FTP server is updated according to a change in status of the master FTP server 211. For example, the master FTP server may be the FTP server having the lowest CPU load. If the CPU load of a original master FTP server is greater than a preset value (e.g., 95%), one slave FTP server having the lowest CPU load currently is selected to be an updated master FTP server, and the tags of the original master FTP server and the selected slave FTP server (i.e., the updated master FTP server) are updated in the configuration table 300.

For example, the tag of the original master FTP server is changed from “1” to “0”, and the tag of the selected slave FTP server (i.e., the updated master FTP server) is changed from “0” to “1”. Thus, the original master FTP server is changed to the slave FTP server, and does not receive documents uploaded from the client computer 121. In one embodiment, the configuration table 300 in the database server 123 is synchronized in accordance with other configuration tables in other branch-nodes (e.g., 113, 133) periodically, for example, once every thirty minutes.

The FTP server system 207 stores documents. For example, the documents may be unstructured documents in various formats such as images, words, sounds and other media. The FTP server system 207 connects with other FTP server system in other branch-nodes 110, 130 via the network 140, and can exchange documents with other branch-nodes 110, 130.

The application server 209 connects to the client computer 121 and the database server 123. The application server 209 sends database processing commands received from the database processing module 203 to the database server 123, and returns the processing results to the database processing module 203.

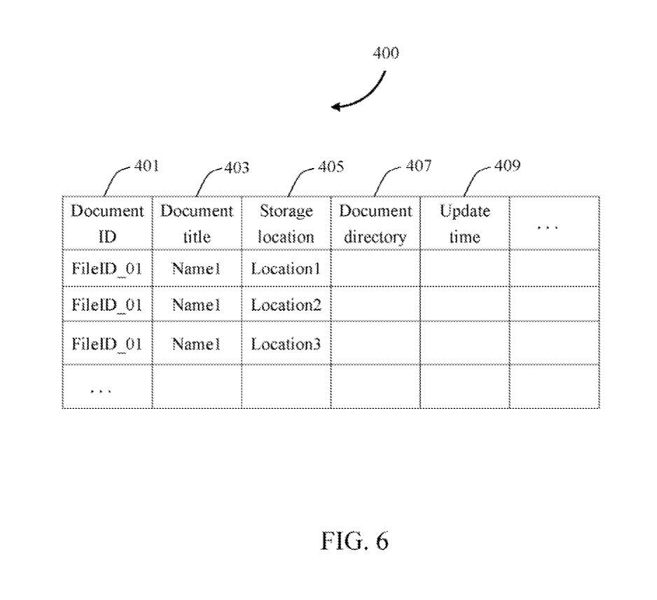

The database server 123 includes a summary table 400 (refer to FIG. 6), which stores summary information of all unstructured documents stored in all FTP servers in the form of structured data. As shown in FIG. 6, the summary information includes a document ID 401, a document title 403, a document storage location 405, a document directory 407, and update time 409 of each document. In one embodiment, the summary table 400 in the database server 123 is synchronized in accordance with other summary tables in other branch-nodes (e.g., 113, 133) periodically, for example, once every thirty minutes.

The document ID 401 is one of a designated set of numbers for various documents stored in the information system. Each of the documents has a unique document ID. The document title 403 records a description of each document. The document location 405 records the IP address or a media access control (MAC) address of an FTP server showing where a document is located, for example, 10.153.24.199. The document directory 407 records a directory of documents in a corresponding FTP server. The update time 409 records a time of the most recent editing of a document.

In other embodiments, the database server 123 may be combined with the application server 209, for example, the functions of the database server 123 may be executed by the application server 209, and thus the database server 123 is removed. The application server 209 may be replaced by other suitable electronic devices, such as a smart phone, or a personal digital assistant (PDA).

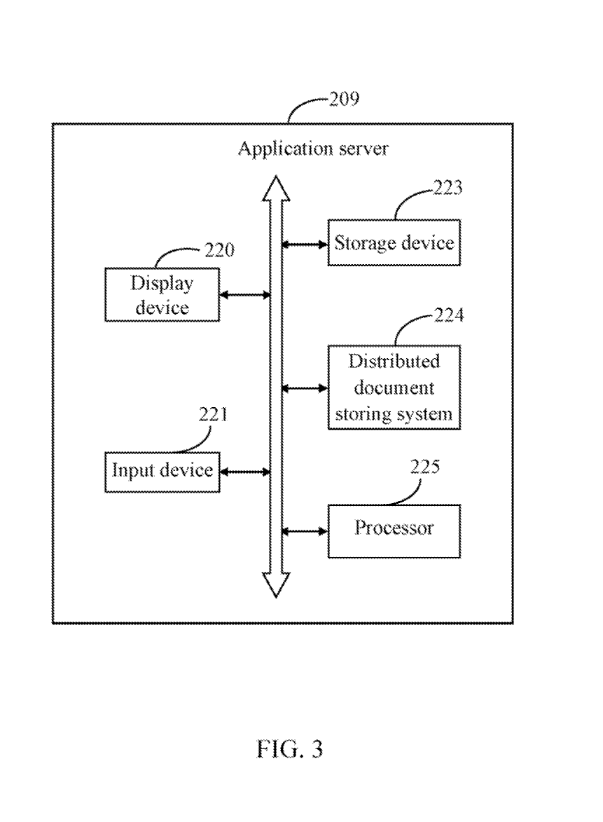

FIG. 3 is a block diagram of one embodiment of the application server 209 including a distributed document storing system 224. In the embodiment, the application server 209 further includes a display device 220, an input device 221, a storage device 223, and at least one processor 225. FIG. 3 illustrates only one example of the application server 209 that may include more or fewer components than illustrated, or have a different configuration of the various components in other embodiments.

The display device 220 may be a liquid crystal display (LCD) device, and the input device 221 may be a mouse or a keyboard used to input computer readable data. The storage device 223 may be a non-volatile computer storage chip that can be electrically erased and reprogrammed, such as a hard disk or a flash memory card.

The distributed document storing system 224 uploads a document to a master FTP server in a first branch-node according to the configuration table 300 in the first branch-node, sends a backup of the uploaded document to the master FTP server in other branch-nodes, and updates a tag of the master FTP server in the configuration table 300 according to a status change of the master FTP server. In one embodiment, the distributed document storing system 224 may include computerized instructions in the form of one or more programs that are executed by the at least one processor 225 and stored in the storage device 223 (or memory). A description of the distributed document storing system 224 is given in the following paragraphs.

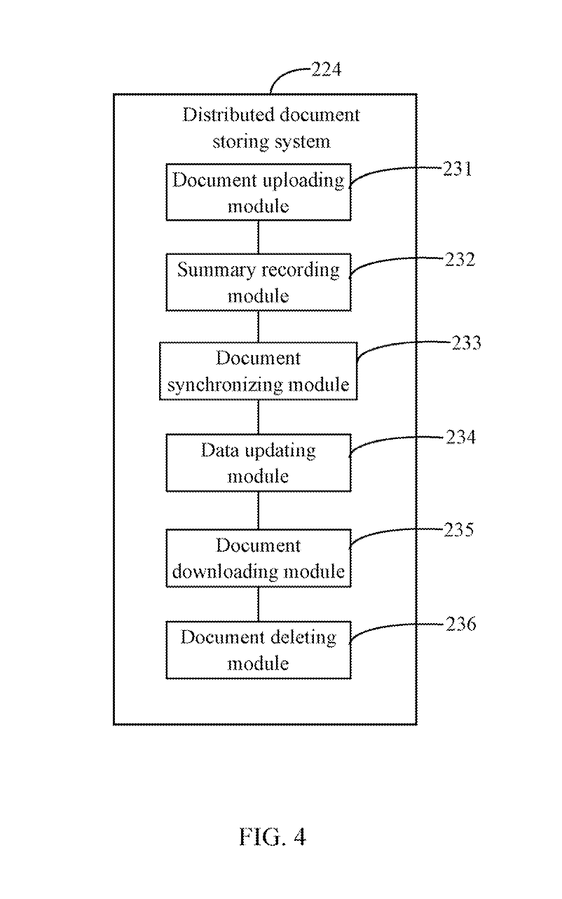

FIG. 4 is a block diagram of function modules of the distributed document storing system 224 included in the application server 209. In one embodiment, the distributed document storing system 224 may include one or more modules, for example, a document uploading module 231, a summary recording module 232, a document synchronizing module 233, a data updating module 234, a document downloading module 235, and a document deleting module 236. In general, the word “module”, as used herein, refers to logic embodied in hardware or firmware, or to a collection of software instructions, written in a programming language. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include flash memory and hard disk drives.

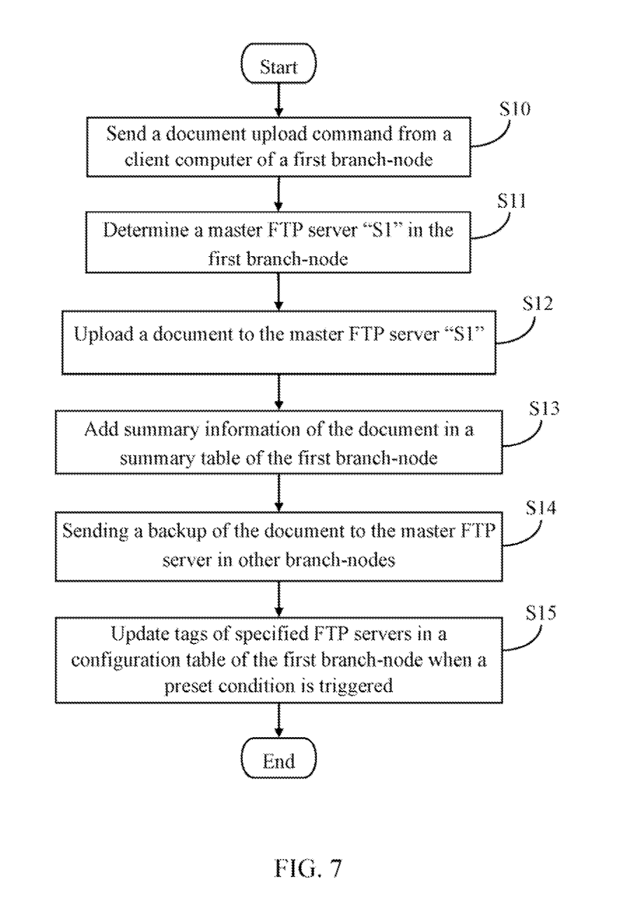

FIG. 7 is a flowchart of one embodiment of a method for storing distributed documents using the application server 209. Depending on the embodiment, additional steps may be added, others removed, and the ordering of the steps may be changed.

In step S10, a client computer of a first branch-node sends a document upload command to an application server. For example, the first branch-node may be the branch-node 120.

In step S11, the document uploading module 231 receives the document upload command, and determines a master FTP server 211 “S1” in the FTP server system 207 of the first branch-node according to the tag of each FTP server recorded in the configuration table 300 of the first branch-node.

In step S12, the document uploading module 231 uploads a document corresponding to the document upload command to the master FTP server “S1”.

In step S13, the summary recording module 232 adds summary information of the document (i.e., the upload document) in the summary table 400 of the first branch-node. For example, the summary information may include a document ID, a document title, a storage location of the document in the first branch-node, a document directory, and update time (e.g., upload time) of the document.

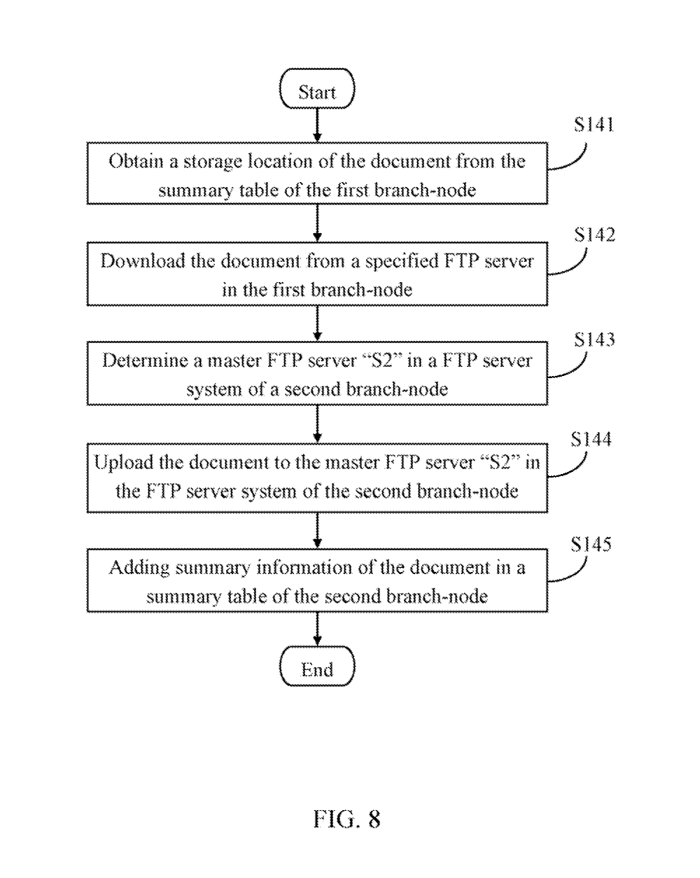

In step S14, the document synchronizing module 233 synchronizes the document by sending a copy of the document to the master FTP servers in other branch-nodes as backup. A description of the synchronization step S14 is shown in FIG. 8.

In another embodiment, the document synchronizing module 233 may send a backup of the configuration table 300 and of the summary table 400 of the first branch-node to other branch-nodes (e.g., 110, 130) at preset intervals (e.g., ten minutes).

In step S15, the data updating module 234 updates the tags of specified FTP servers in the configuration table 300 of the first branch-node when a preset condition is triggered. In another embodiment, step S15 may be executed before step S14.

For example, if the CPU load (or other parameters, such as memory usage ratio) of an original master FTP server is greater than a preset value (e.g., 95%) and the preset condition is triggered, then the data updating module 234 selects a slave FTP server having lowest CPU load from the first branch-node, the selected slave FTP server is determined and treated as an updated master FTP server. In other embodiments, the updated master FTP server may be selected randomly from the slave FTP servers in the first branch-node. The data updating module 234 changes the tag of the updated master FTP sever to a first value, and changes the tag of the original master FTP server to a second value so that the original master FTP server becomes a slave FTP server. For example, the first value is “1”, and the second value is “0”.

In other embodiments, the method further includes the step of obtaining a storage location of a specified document from the summary table 400 by the document downloading module 235 when a document download command is received from the client computer 121 in the first branch-node. The document downloading module 235 downloads the specified document from a corresponding FTP server of the first branch-node according to the storage location of the specified document.

In other embodiments, the method further includes the step of obtaining all storage locations of a specified document from the summary table 400 by the document deleting module 236 when a document delete command is received from the client computer 121 in the first branch-node. The document deleting module 236 deletes the specified document from a corresponding FTP server of each branch-node according to each obtained storage location of the specified document.

FIG. 8 is a flowchart of a detailed description of step S14 in FIG. 7. Depending on the embodiment, additional steps may be added, others removed, and the ordering of the steps may be changed. In this embodiment, the document synchronizing module 233 synchronizes the documents to the other master FTP servers of the FTP server systems in other branch-nodes at the same time using multi-threading method. A description of the synchronization process of the document between the branch-nodes 120 and 130 is as follows.

In step S141, the document synchronizing module 233 obtains a storage location of the document from the summary table 400 of the first branch-node according to a document ID of the document.

In step S142, the document synchronizing module 233 downloads the document from a specified FTP server of the FTP server system in the first branch-node according to the storage location of the document. The original master FTP server 211 may be changed at that time. However, the IP address (or the MAC address) of the original master FTP 211 is not changed, thus the storage location of the document is not changed even though the original status of the master FTP server is changed in the first branch-node.

In step S143, the document synchronizing module 233 determines a master FTP server “S2” in a FTP server system of a second branch-node (e.g. branch-node 130) according to a summary table of the second branch-node.

In step S144, the document synchronizing module 233 uploads the document to the master FTP server “S2” in the FTP server system of the second branch-node 130.

In step S145, the document synchronizing module 233 adds summary information of the document in the summary table 400 of the second branch-node 130. For example, the summary information may include the document ID, the document title, the storage location of the document in the second branch-node, the document directory, and the update time (e.g., upload time) of the document.

In the embodiments, the documents are stored in a plurality of FTP servers, the FTP servers include a master FTP server and one or more slave FTP servers, where the master FTP server is used to upload and download documents, the slave FTP server is used to download documents, and the upload operation and the download operation of the documents may be executed on different FTP servers at the same time, to improve access speed of the documents of the FTP servers. In addition, when one FTP server is damaged, the documents stored are not lost, to improve data security. If the storage space of the original master FTP server is not enough, a slave FTP server may be selected as an updated master FTP server from the FTP server system by changing the tag of the selected slave FTP server in the configuration table 300. There is no need to buy a larger storage capacity and more expensive server.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for storing distributed documents using an electronic device, the method comprising:
receiving a document upload command from a client computer of a first branch-node, and determining a first master file transfer protocol (FTP) server in the first branch-node according to tags of all FTP servers of the first branch-node, the tags of all the FTP servers being recorded in a configuration table of the first branch-node;
uploading a document corresponding to the document upload command to the first master FTP server;
adding summary information of the document in a summary table of the first branch-node; and
updating tags of specified FTP servers in the configuration table of the first branch-node when a preset condition is triggered.

2. The method according to claim 1, wherein the tags of the specified FTP server are updated by:
selecting a slave FTP server from the first branch-node when a specified parameter of an original master FTP server is greater than a preset value, the selected slave FTP server being determined as an updated master FTP server; and
changing the tag of the updated master FTP sever to a first value, and changing the original master FTP server to a slave FTP server by changing the tag of the original master FTP server to a second value.

3. The method according to claim 1, further comprising:
synchronizing the document by sending a backup of the document to a second master FTP server of a second branch-node.

4. The method according to claim 3, wherein the synchronizing step comprises:
obtaining a storage location of the document from the summary table of the first branch-node according to a document ID of the document;
downloading the document from a specified FTP server of the first branch-node according to the storage location of the document;
determining a second master FTP server in the second branch-node according to a summary table of the second branch-node;
uploading the document to the second master FTP server in the second branch-node; and
adding summary information of the document in the summary table of the second branch-node.

5. The method according to claim 3, further comprising:
sending a backup of the configuration table and the summary table of the first branch-node to the second branch-node after a preset time interval.

6. The method according to claim 1, further comprising:
obtaining a storage location of a specified document from the summary table of the first branch-node when a document download command is received from the client computer in the first branch-node; and
downloading the specified document from a corresponding FTP server of the first branch-node according to the storage location of the specified document.

7. The method according to claim 1, further comprising:
obtaining all storage locations of a specified document from the summary table of the first branch-node when a document delete command is received from the client computer in the first branch-node; and
deleting the specified document from all FTP servers of the branch-nodes according to the obtained storage locations of the specified document.

8. An electronic device, comprising:
a processor;
a storage device storing a plurality of instructions, which when executed by the processor, causes the processor to:
receive a document upload command from a client computer of a first branch-node, and determine a first master file transfer protocol (FTP) server in the first branch-node according to tags of all FTP servers of the first branch-node, the tags of all the FTP servers being recorded in a configuration table of the first branch-node;
upload a document corresponding to the document upload command to the first master FTP server;
add summary information of the document in a summary table of the first branch-node; and
update tags of specified FTP servers in the configuration table of the first branch-node when a preset condition is triggered.

9. The electronic device according to claim 8, wherein the tags of the specified FTP server are updated by:
selecting a slave FTP server from the first branch-node when a specified parameter of an original master FTP server is greater than a preset value, the selected slave FTP server being determined as an updated master FTP server; and
changing the tag of the updated master FTP sever to a first value, and changing the original master FTP server to a slave FTP server by changing the tag of the original master FTP server to a second value.

10. The electronic device according to claim 8, wherein the plurality of instructions further comprise:
synchronizing the document by sending a backup of the document to a second master FTP server of a second branch-node.

11. The electronic device according to claim 10, wherein the synchronizing step comprises:
obtaining a storage location of the document from the summary table of the first branch-node according to a document ID of the document;
downloading the document from a specified FTP server of the first branch-node according to the storage location of the document;
determining a second master FTP server in the second branch-node according to a summary table of the second branch-node;
uploading the document to the second master FTP server in the second branch-node; and
adding summary information of the document in the summary table of the second branch-node.

12. The electronic device according to claim 10, wherein the plurality of instructions further comprise:
sending a backup of the configuration table and the summary table of the first branch-node to the second branch-node after a preset time interval.

13. The electronic device according to claim 8, wherein the plurality of instructions further comprise:
obtaining a storage location of a specified document from the summary table of the first branch-node when a document download command is received from the client computer in the first branch-node; and
downloading the specified document from a corresponding FTP server of the first branch-node according to the storage location of the specified document.

14. The electronic device according to claim 8, wherein the plurality of instructions further comprise:
obtaining all storage locations of a specified document from the summary table of the first branch-node when a document delete command is received from the client computer in the first branch-node; and
deleting the specified document from all FTP servers of the branch-nodes according to the obtained storage locations of the specified document.

15. A non-transitory storage medium having stored thereon instructions that, when executed by a processor of an electronic device, causes the electronic device to perform a method for storing distributed documents, the method comprising:
receiving a document upload command from a client computer of a first branch-node, and determining a first master file transfer protocol (FTP) server in the first branch-node according to tags of all FTP servers of the first branch-node, the tags of all the FTP servers being recorded in a configuration table of the first branch-node;
uploading a document corresponding to the document upload command to the first master FTP server;
adding summary information of the document in a summary table of the first branch-node; and
updating tags of specified FTP servers in the configuration table of the first branch-node when a preset condition is triggered.

16. The non-transitory storage medium according to claim 15, wherein the tags of the specified FTP server are updated by:
selecting a slave FTP server from the first branch-node when a specified parameter of an original master FTP server is greater than a preset value, the selected slave FTP server being determined as an updated master FTP server; and
changing the tag of the updated master FTP sever to a first value, and changing the original master FTP server to a slave FTP server by changing the tag of the original master FTP server to a second value.

17. The non-transitory storage medium according to claim 15, wherein the method further comprises:
synchronizing the document by sending a backup of the document to a second master FTP server of a second branch-node.

18. The non-transitory storage medium according to claim 17, wherein the synchronizing step comprises:
obtaining a storage location of the document from the summary table of the first branch-node according to a document ID of the document;
downloading the document from a specified FTP server of the first branch-node according to the storage location of the document;
determining a second master FTP server in the second branch-node according to a summary table of the second branch-node;
uploading the document to the second master FTP server in the second branch-node; and
adding summary information of the document in the summary table of the second branch-node.

19. The non-transitory storage medium according to claim 17, wherein the method further comprises:
sending a backup of the configuration table and the summary table of the first branch-node to the second branch-node after a preset time interval.

20. The non-transitory storage medium according to claim 15, wherein the method further comprises:
obtaining a storage location of a specified document from the summary table of the first branch-node when a document download command is received from the client computer in the first branch-node; and
downloading the specified document from a corresponding FTP server of the first branch-node according to the storage location of the specified document.
